(19) United States
(12) Patent Application Publication
(10) Pub. No.: US 2013/0193074 A1
(43) Pub. Date: Aug. 1, 2013

(54) WATER TREATMENT PROCESS

(71) Applicants: Peter Voigt, Tuerong (AU); Michael Hollitt, Kew East (AU); Nikolai Zontov, Keysborough (AU)

(72) Inventors: Peter Voigt, Tuerong (AU); Michael Hollitt, Kew East (AU); Nikolai Zontov, Keysborough (AU)

(73) Assignee: CLEAN TEQ HOLDINGS LTD., Dandenong South, Victoria (AU)

(21) Appl. No.: 13/697,755

(22) PCT Filed: May 13, 2011
(86) PCT No.: PCT/AU2011/000568

§ 371 Date: Feb. 7, 2013

(30) Foreign Application Priority Data
May 13, 2010 (AU) 2010902072

(51) Int. Cl. C02F 1/42

(52) U.S. Cl. CPC C02F 1/42
USPC 210/638; 210/663; 210/664; 210/668

(57) ABSTRACT

A water treatment process for substantially removing one or more ionic species from a feed water includes an ion containing aqueous solution to produce a treated water product, the process including: (a) a sorption step, including contacting a solid sorbent with said feed water to produce a solution depleted in said one or more ionic species and a loaded sorbent; (b) a concentrating step, includes concentrating an inlet stream including the ionic species depleted solution to produce a concentrate rich in said one or more ionic species and said treated water product; and (c) a desorbing step, including contacting said loaded sorbent with an aqueous desorbant including said concentrate to thereby desorb at least some of said one or more ionic species from said loaded sorbent.

This invention relates to treatment of water to remove dissolved components.

This invention relates more particularly but by no means exclusively to an integrated sorption-concentration-desorption process for water treatment that enables treatment of water to provide enhanced recoveries of product water.

Treatment of water may be conducted commercially for one or more of the following purposes:
to avoid discharge of contaminated water to environmental receptors, by concentrating contaminants into a small volume relative to the availability of area that can be allocated to net local natural evaporation,
to produce a treated water stream that can be applied in economically beneficial uses or for direct human consumption, or
to assist with the recovery of valuable components, by increasing the concentration of these components so that separation from water, for example by crystallisation or precipitation, is facilitated.

Where the purpose of water treatment is water recovery for beneficial use, especially where the water is derived from locations that are inland, there is often an incentive to maximise water recovery because of a limited resource of water that can be treated. There is also an incentive to produce a small volume of concentrate or brine containing the main contaminants so that area for containment and natural evaporation of this concentrate or brine can be limited to be commensurate with area that is available.

Where the purpose is to recover potentially valuable components there is also an incentive to produce a high concentration effect so that downstream recovery processes for these components can be conducted at low costs at relatively small scale.

Commercial processes for producing a concentration effect in water treatment include the following:
membrane processes that apply pressure or electrical potential for the purposes of overcoming osmotic forces and flow resistance in retaining dissolved species when water or particular components are preferentially passed through the membrane,
evaporative processes, in which thermal or mechanical energy is used to evaporate water, leaving dissolved species in a smaller, concentrated stream, and
ion exchange processes, in which dissolved ionic species are sorbed onto solids having the ability to replace these ionic species in solution with hydronium and hydroxide ions. This process can be reversed by contact of the solids with strong acids and strong bases at suitable concentrations to desorb the ionic species into smaller, concentrated eluate streams.

Membrane based concentration processes include reverse osmosis and electrodialysis.

Evaporative concentration processes include multistage flash evaporation, multiple effect evaporation, and vapour compression distillation.

Ion exchange processes for producing a concentration effect include deionisation for water purification.

Each of these processes is limited in the concentration effect that can be economically achieved.

Membrane based processes, are economically effective compared with alternative methods up to a particular ionic strength in the concentrate that is dependent on the cost of electrical or other motivating power relative to the cost of available thermal energy. In membrane processes the incremental cost of water recovered increases dramatically with the brine concentration obtained.

Evaporative processes, for which the incremental cost of distillation of the water that is recovered is much less dependent on the concentration effect achieved, are economically effective where a high final concentration of brine is desired (for a low discard volume), or where there is a source of low value waste heat.

Ion exchange as applied alone for water treatment has the disadvantage of requiring consumption of reagents that are used to desorb the ionic species from the ion exchange material. The quantity of reagents consumed depends on the concentration of salts to be removed from the feed water. While capable of producing high concentration effects technically, the limitations on feedwater strength for acceptable economics in ion exchange have generally restricted its use to clean up of water whose ionic strength is relatively low, and presents less of an issue for direct use or discharge than the presence of particular contaminants, and also to production of high purity deionised water.

There are other limitations on the concentration effect that can be achieved using commercially applied processes. In particular, both membrane processes and the evaporative processes that are thermally effective use large contact areas to separate permeate or distillate streams from concentrate streams. Even with chemical pre-treatment, e.g. acidification, at some feedwater to concentrate ratios (high concentration effect) the concentrate (brine) stream will normally become supersaturated relative to particular solid compounds, which compounds may include calcium, strontium and barium sulphates and carbonates as well as silicates and colloidal silica. These solid products separate preferentially onto membrane and heat exchange surfaces, creating fouling and scaling that reduces process effectiveness and requires frequent cleaning. While anti-scalant additives are commercially available, these additives merely increase the supersaturation at which fouling and scaling occurs, and so alleviate but do not remove the limitation that scaling and fouling represents to high concentration effects.

Most water that is processed commercially for water recovery or environmental protection, including brackish groundwater, industrial and metals processing wastewater, and water from natural or induced acid rock drainage, will contain components that can produce fouling and scaling hereinafter referred to as “scale promoting components”. It would therefore be desirable to provide a process for the treatment of water in which the components that can contribute to fouling and scaling are removed or reduced from water prior to entering the concentration step.

The components of feedwater that have the highest impact on the propensity to produce sulphate, carbonate and silica scale in concentration processes are salts of one or more of the Group II elements calcium, strontium and barium, aided under some circumstances by aluminium and magnesium. The term “calcium subgroup components” will hereinafter be used to refer to one or more of the elements calcium, strontium and barium.

Removal of these components prior to a membrane or evaporative concentration step has been achieved in a number of prior art pre-treatments based on ion exchange, involving exchange of these ionic components for other ionic components that do not have the same propensity to induce scaling and fouling.

The effects of scaling and fouling can be substantially reduced by the ion exchange treatment. The concentration effect that is practically achievable in a concentration step is then limited mainly by the economics of the concentration method and the constraint of available area for brine disposal and natural evaporation rather than the limitations introduced by scaling and fouling. For example, evaporative distillation may be used to further concentrate the brine produced from two or more sequential stages of reverse osmosis, thereby achieving a significant reduction in concentrate volume that enters storages for reduction by natural evaporation.

Such cationic exchange is typically conducted either in fixed bed carousel processes (cartridges moving between sorption and desorption), in fluidised bed processes, or in moving packed bed processes in which the solid sorbent is moved between sorption and desorption in intermittent pulses. Depending on the application and the feedwater composition either strong or weak cationic exchange sorbents are used.

In some cases sodium salts are used in desorption, so that net sorption of mainly trivalent and divalent cations is achieved, providing a selectivity for these elements in sorption that avoids the high reagent consumption that would attach to non selective sorption of contained cations, including sodium.

However, none of these processes are selective for calcium subgroup components. In all cases, magnesium that is present is also taken onto the sorbent and must be displaced by added strong reagents in desorption.

Magnesium is commonly the second largest contributor to ionic strength in feedwaters that require treatment, after sodium. Consumption of reagents in the desorption of magnesium from the loaded sorbent will frequently be the largest contributor to reagent costs in such processes.

Further, for other than relatively low ionic strength feedwater the costs of reagent consumption in treatment of water by ion exchange are such that the value of product water is often less than the process costs. In such cases water treatment carries a substantial net cost, and will often be avoided in favour of large evaporation areas, where permitted, with significant implications for alternative land uses in perpetuity.

That is, these processes fail to avoid the customary disadvantage of ion exchange, of being economically limited to treatment of water having low to moderate ionic strength.

One prior art process used for treating a particular type of water containing high bicarbonate and/or chloride content possibly together with silica includes a cationic ion exchange step prior to reverse osmosis concentration step. Such water includes groundwater associated with conditions under which methane has been naturally formed.

While having relatively low concentrations of scale promoting components such as calcium subgroup components, the other components of this water, particularly silica, and bicarbonate that is in equilibrium with carbonate, enable solids that can promote scaling and fouling to be formed upon concentration of the water even for these low starting concentrations.

The use of cationic ion exchange is superior to simple acidification of this water (for alkalinity adjustment to prevent calcium subgroup components from precipitating) prior to reverse osmosis because it does not need an acid reagent and maintains pH within a range in which silica is less likely to foul membranes. However, removal of calcium subgroup components must be substantially complete in ion exchange in this case since transfer of calcium into reverse osmosis without further alkalinity control will result in almost quantitative conversion to carbonate scale. To achieve this, desorption of these components from the sorbent must be substantially complete, requiring poor utilisation of the added salt reagent, whose high consumption adds a significant cost and also contributes to the salts loading in the desorption eluate that must be disposed of.

An alternative prior art process similarly applies cationic ion exchange prior to reverse osmosis but uses acid as desorbant, so that bicarbonate is decomposed by acid released into sorption. However, this process consumes significant quantities of acid in desorption, exceeding even the high amount required for bicarbonate decomposition.

Another prior art process comprises an anionic exchange step followed by a nanofiltration step which allows recovery of desorbent chemicals. However, this process does not reduce total dissolved solids. Moreover, reagent consumption is still significant.

Another means of reducing scaling or fouling is by employing direct precipitation processes. Such processes include for example lime or caustic softening, with and without carbonate addition, and are employed for removal of calcium subgroup components, as well as aluminium, potentially magnesium, and most other metallic impurities. These impurities are removed as carbonate and hydroxide solids by settling and filtration at elevated pH. These processes may be employed upstream to application of a membrane or evaporative concentration step for water recovery, with the concentration step sometimes preceded by acidification to avoid residual carbonate scale formation in the concentration step, depending on the residual cation levels that are present and the concentration ratio that is targeted.

However, direct precipitation processes have the disadvantage of production of large quantities of sludges while requiring precipitation reagent consumption that is still proportional to the concentration of scale promoting elements in the feedwater. Further, there is a limitation on the extent to which the concentration of scale promoting components can be reduced by these methods, with a commensurate limitation on the concentration ratio that can be applied in a subsequent concentration step while avoiding scale formation.

To date, there has been no water treatment process that operates ion exchange for removal of promoters of scaling and fouling prior to a concentration step that does not require consumption of reagents in desorption of these and other unselectively sorbed components. That is, all combinations of ion exchange and concentration processes that have been applied or proposed in the prior art add the full costs of the concentration step to the full costs of the ion exchange step.

Consequently, water treatment processes in the prior art that work to achieve a high concentration effect while avoiding scaling and fouling inevitably involve a significantly higher cost per unit of water recovered than those that work to a low concentration effect.

It is to be understood that, any reference to prior art herein, does not constitute an admission that the prior art forms a part of the common general knowledge in the art, in Australia or any other country.

It is accordingly an object of the present invention to provide a water treatment process which overcomes, or at least alleviates, one or more disadvantages of the prior art.

According to the present invention, there is provided a water treatment process for substantially removing one or more ionic species from a feed water comprising an ion containing aqueous solution to produce a treated water product, the process including:
(a) a sorption step, comprising contacting a solid sorbent with said feed water to produce a solution depleted in said one or more ionic species and a loaded sorbent;
(b) a concentrating step, comprising concentrating an inlet stream including the ionic species depleted solution to produce a concentrate enriched in said one or more ionic species and said treated water product; and
(c) a desorbing step, comprising contacting said loaded sorbent with an aqueous desorbant including said concentrate to thereby desorb at least some of said one or more ionic species from said loaded sorbent.

The water treatment process of the invention may further include the step of:
(d) recycling the solid sorbent after desorption to said sorption step (a).

In an embodiment of the water treatment process the ionic species includes divalent cation containing ionic species. The divalent cation containing ionic species may include one or more of calcium, barium, strontium and iron containing species. Preferably, the depleted divalent cation containing ionic species include calcium-containing species.

In an embodiment of the water treatment process the sorption step (a) comprises an ion exchange step and the solid sorbent comprises an ion exchange material. The ion exchange material may comprise an ion exchange resin, such as a cation exchanger, preferably in granular form.

Alternatively, the sorbent may comprise some other material that operates under a different mechanism. In the case of an ion exchange material, it can be of any known type of exchanger in macroporous, mesoporous, microporous, or gel granular form. The sorbent can optionally be a weak acid exchanger or a strong acid exchanger or cationic exchanged forms of these exchangers. Where anionic exchange is optionally used (to remove anions that contribute to scaling and fouling in combination with cationic components) the sorbent can optionally be a strong base exchanger or a weak base exchanger or anionic exchanged forms of these exchangers. The chemical action of the sorbent can optionally be based on an inorganic chemical exchange (e.g. as in zeolites) or an organic chemical exchange (e.g. as in organic ion exchange resins). If the sorbent is an organic ion exchange resin it can be formed from any suitable polymeric substrate.

In an embodiment of the water treatment process the concentrating step (b) includes a membrane process which utilises a membrane for producing said concentrate and said treated water product. The membrane process may comprise reverse osmosis.

In an embodiment of the water treatment process, the concentrating step includes an evaporative process.

The concentrating step (b) may be conducted in any suitable manner. Concentration may be conducted in multiple stages using different concentration techniques in successive stages according to the conditions at each stage or the economically selected optimum for each stage in the context of the feed water source for treatment. For example, a brackish water reverse osmosis step may be used to produce a concentrate that is further concentrated in a salt water reverse osmosis step that produces a brine that is finally concentrated in an evaporative step such as distillation using mechanical vapour compression. The concentrate may be further concentrated in an evaporation pond prior to its use in producing a desorbant.

This invention is based on a surprising discovery that it is possible in processes for the treatment of water containing dissolved salts to enhance product water recovery (either as liquid water or water vapour), with reduced production of contaminated waste water, while reducing fouling of process equipment, and also reducing consumption of chemical reagents. It has been surprisingly found that these multiple benefits can be obtained by coupling a concentration step, such as a desalination or evaporation step, with a sorption step, such as an ion exchange step, where the sorption step is used for the preferential removal of components that promote scaling before water enters desalination or evaporation equipment to produce a concentrated stream, and where the concentrated stream from desalination or evaporation is used as a principal component of the desorbant that is applied to regeneration of the ion exchange medium.

Accordingly, the inventors have surprisingly found that the concentrated stream which is rich in the ionic species (concentrate or brine) that is separated from distillate or permeate in the concentration step can be highly effective as a desorbant, particularly in ion exchange. That is, ion exchange can be operated in such a manner that components in the feed water that would promote fouling and scaling are removed at least in part by sorption, with regeneration of the sorbent medium for optional re-use by contact with a concentrated solution of the remaining components.

The process of the present invention may be used to treat aqueous solutions having a wide variety of compositions and types. The aqueous solution may comprise a naturally occurring water, such as saline or brackish water. Alternatively, the aqueous solution may be man-made, such as solutions derived from various industrial or mining operations. Examples of such aqueous solutions include those derived from acid rock drainage, from produced water in recovering coal seam methane, from process water for enabling recycling or environmental release, and from groundwater for enabling economic use or human consumption or for reducing near surface salinity.

The aqueous solution may also comprise a product stream from another water treatment process used to process or treat water. The aqueous solution may be a concentrated stream or a chemically treated stream. An example is that the process can be used to treat the product water from lime or caustic soda and soda ash softening to enhance the concentration ratios that can be achieved via this process alone. A further example is that the process of this invention can be used to further concentrate streams that have been obtained from membrane or evaporative concentration steps where the concentration effect obtained has been limited by the possibility of scaling and fouling.

In an embodiment of the process of this invention the ion containing aqueous solution comprises water having a very low magnesium concentration but substantial sodium concentration. In particular, water having low calcium and high bicarbonate content or high chloride content or both can be treated at high concentration ratios while scaling and fouling is controlled. This class of water may also contain quantities of silica that can in some circumstances foul concentration processes, but in any case must be removed for many beneficial water uses. When associated with genesis under reducing conditions (e.g. groundwater associated with conditions under which methane has been naturally formed) the water is generally of low sulphate content.

Large volumes of water of this type are brought to surface when formations containing non conventional gas such as coal seam methane (or coal seam gas) are dewatered prior to gas recovery. The water commonly contains sufficient dissolved solids that it is unsuitable for economic application unless treated, and its generation at surface has created issues for alternative beneficial land use due to the need for large containment areas for evaporation that leave brine lakes that cannot be easily rehabilitated.

The process steps of the present invention can optionally be used in combination with other water treatment steps. Such additional steps may include filtration, ultrafiltration, oxidation, neutralisation, precipitation, settling, acidification for alkalinity adjustment, chemical additions to reduce scaling, reverse osmosis, electrodialysis, multistage flash evaporation or distillation, multiple effect evaporation or distillation, and vapour compression distillation, applied appropriately within, prior to, subsequent to or in conjunction with the process of the present invention while maintaining the benefits of reduced reagent consumption and high concentration effect achieved.

In the case of treating an ion containing aqueous solution containing elevated carbonate levels, the feed stream to concentration step (b) is advantageously pre-treated by acidification to reduce alkalinity, thereby increasing the solubility of calcium in the concentrated stream from step (b) by avoiding precipitation of carbonates.

In the case of treating an ion containing aqueous solution having elevated mineral acidity, prior to the ion exchange step (a), the solution may be pre-treated by neutralisation for removal by precipitation and separation of specific metallic species, or reduction of mineral acidity that is carried with aluminium and iron components, reducing the need for aggressive sorbent regeneration.

Alternatively, acidification for adjustment of alkalinity can be conducted following ion exchange and prior to the concentration step. A further acidification step can optionally be conducted on the concentrate prior to its use in desorption in cases where pH increase occurs in the concentration step (e.g. where that step involves reverse osmosis), reducing the potential for precipitation and scale formation in that step.

In general, higher recoveries of treated water product in the concentration step will be facilitated by higher degrees of removal of scale promoting elements in the cationic exchange step to avoid scaling or fouling in the concentration step.

In the process of the present invention, anti-scalant chemicals may optionally be added at any stage, with most benefits obtained where needed by addition to the concentrate prior to its use in desorption, and with benefits in some cases (e.g. where very high concentration ratios are desired) from addition to the feed stream of the concentration step.

The use of the concentrate from the concentration step (b) as a desorbant significantly reduces or eliminates the need for addition of chemicals in the desorption step. However, in some cases it will be beneficial to supplement the concentrate from step (b) with additions of chemicals that either assist with desorption or assist in maintaining the stability of the eluate solution. This supplementation optionally includes but is not limited to the addition of salts that enhance the sorption of sodium or magnesium relative to calcium sorption or acid or salts that may have the impact of aiding desorption when the selectivity difference provided by the concentrate is insufficient to provide for the desired calcium, barium and strontium in water entering the concentration step at the design water to sorbent ratio in the sorption step. Such salts may include sodium salt.

Further, the concentrate produced from any stage of a concentration process may find usefulness at least as a component of a desorbant in step (c) of the process of the invention. Where beneficial to process effectiveness or economics particular components in the concentrate from any stage of concentration can be removed or recovered by any suitable technique, e.g crystallisation, chemical precipitation, solvent extraction or ion exchange, prior to use of the concentrate in producing a desorbant.

The sorption step (a) can be conducted via a number of effective means of contacting the sorbent with feed water. For example, the sorbent that is returned from the desorption step (c) can be presented in cartridges or containers containing solid sorbent through which the feed water passes in step (a). In this approach, when the exit water from a cartridge in step (a) reaches a threshold concentration of calcium, barium or strontium the cartridge or container is removed and presented for desorption, and is replaced with a cartridge or container of sorbent that has been subjected to desorption by contact with concentrate from the concentration step (b). The cartridges or containers may be mounted on carousels, or manifolds and valve configurations that enable switching of flows between feed water and concentrate can be applied to achieve this purpose. Cartridges or containers of sorbent may optionally be cycled through draining or rinsing between the duties of steps (c) (desorption) and (a) (sorption).

Multistage contacting, especially counter-current contacting in which the sorbent cartridge or container that has most recently returned from desorption in step (c) treats water from earlier stages of sorption in step (a) while the next cartridge or container of loaded sorbent to return to desorption is removed from contact with the feed water, can also be conducted with these cycling fixed bed systems.

The sorbent that is returned from desorption step (c) may also be contacted with feed water in step (a) in a fluidised bed, or series of fluidised beds operated in counter-current mode, with separation of sorbent from water within or between successive stages, and with both sorbent and water moving between the stages.

In a preferred method of operation the sorbent that is returned from desorption step (c) is contacted with feed water in step (a) in a moving column of granular sorbent, where the sorbent is either continuously or preferably intermittently discharged by gravity downwards, or by an upwards air lift pulse or upwards water pulse, with the column of sorbent preferably moving in a counter-current direction to the feed water. In this manner the loading of components onto sorbent leaving step (a) is optimised by continual contact with fresh feed water and water entering the concentration step has also been continually contacted with the least loaded sorbent delivered immediately from step (c).

The loaded sorbent that enters step (c) may be contacted via any suitable means with the desorbant whose volume consists at least in large part of the concentrated stream from step (b). Contacting may be by passage of desorbant through cartridges or containers of batched sorbent, possibly conducted in a stagewise fashion with desorbant passed through cartridges or containers in series. In the case of such stagewise operation it is preferred that the least loaded (most desorbed) sorbent contacts the fresh desorbant solution, and that the most loaded sorbent (most recently contacted with feed water in step (a) contacts the desorbant solution that has already had the most contact and component transfer.

The sorbent that is returned from sorption step (a) may also be contacted with desorbant in step (c) in a fluidised bed, or series of fluidised beds operated in counter-current mode, with separation of sorbent from desorbant within or between successive stages, and with both sorbent and desorbant moving between the stages.

In a preferred method of operation the sorbent that is returned from sorption step (a) is contacted with desorbant in step (c) in a moving column of granular sorbent, where the desorbed sorbent is either continuously or preferably intermittently discharged by gravity flow downwards, or by an upwards air lift pulse or upwards water pulse, with the column of sorbent preferably moving via such action in a counter-current direction to the desorbant. In this manner the desorption of components from the sorbent leaving step (c) is optimised by continual contact with the concentrated stream directly delivered from step (b) and water leaving the process in step (c) has also been continually contacted with the most loaded sorbent delivered immediately from step (a).

Where moving columns of granular sorbent are used for the sorption step (a) and the desorption step (c) it is preferred that by action of gravity in one of the steps and the action of air lift or water pulsing in the other of these steps the sorbent moves semi-continuously between the two steps conducted in parallel columns, one of which takes loaded sorbent in counter-current flow to desorbant, with the other taking desorbed sorbent in counter-current flow to feed water.

Where the desorbed sorbent of step (c) is recycled to the sorption step (a) it may be drained and then may be washed to avoid associated concentrated desorbate entering sorption.

The counter-current contacting may be effected using a Higgins loop. This technique allows the avoidance of desorbant entering sorption by injection of wash water into the sorbent bed between the exit water withdrawal point of step (a) and the desorbant addition point of step (c).

Embodiments of the invention will now be described by way of example only with reference to the accompanying drawing and the following Examples.

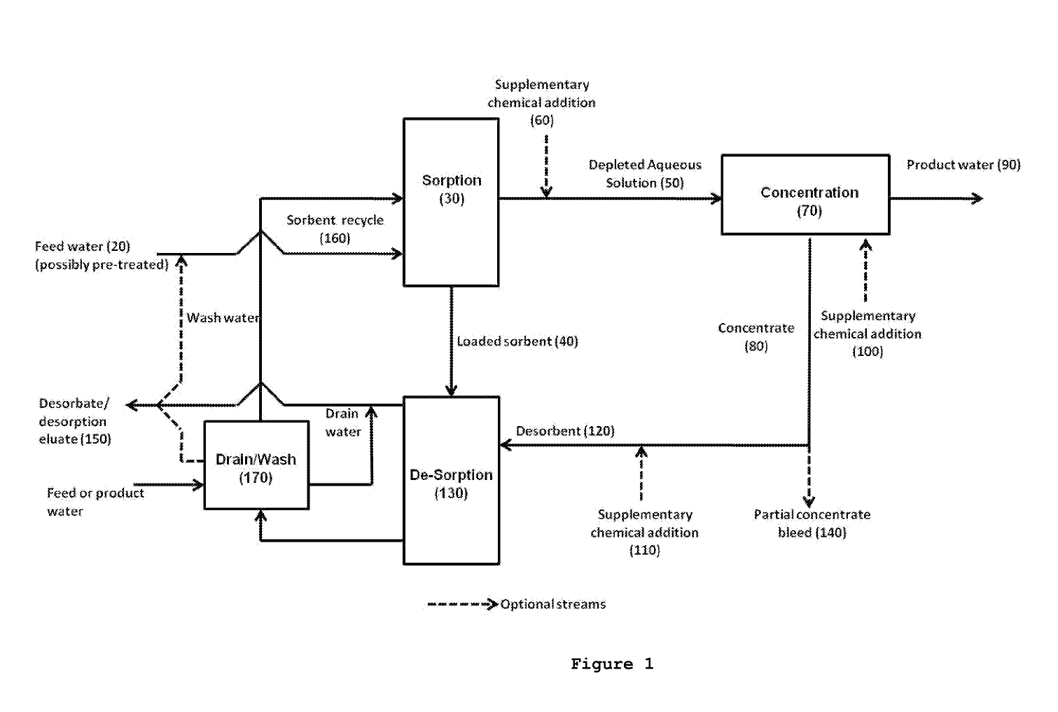

FIG. 1 is a schematic flowsheet illustrating an embodiment of the water treatment process of the invention.

FIG. 1 illustrates a flowsheet (10) illustrating an embodiment of the water treatment process of the invention. A feed water (20) comprising an aqueous solution containing one or more ionic species, is optionally pre-treated, then fed to a sorption step (30). The sorption step (30) comprises contacting a cationic ion exchange resin with the feed water to produce a loaded sorbent (40) and an aqueous solution depleted in the one or more ionic species (50). The depleted aqueous solution (50) is optionally supplemented with one or more chemical additives (60). The depleted aqueous solution (50) is fed to a concentration step (70) in which the depleted aqueous solution (50) is subjected to concentration to produce a concentrate (80) and a treated product water (90). The concentration step (70) may optionally include addition of supplementary chemicals (100). The concentrate (80), optionally together with supplementary chemical additives (110), is fed as an aqueous desorbant (120) to a desorption step (130) to thereby desorb at least some of said one or more ionic species from the loaded sorbent (40). The concentrate (80) may also be partially bled (140) prior to being fed to the desorption step (130). The eluate (150) from the desorption step (130) is then recovered for further processing if required or sent to disposal. The desorbed sorbent (160) is drained and washed (170), then recycled back to the sorption step (30) for reuse.

### EXAMPLE 1

A metal ion containing aqueous solution containing at least one of calcium, barium or strontium as well as other salts including magnesium and sodium salts is fed to step (a). Cationic exchange in step (a) with a sorbent that is recycled from step (c) can be operated in such a manner that there is a smaller proportion of the magnesium sorbed from the feed water compared with the proportion of sorbed calcium.

Under these circumstances there will be little or no sorption of sodium from the feed water (sodium will be desorbed in the sorption step (a) when the water treatment process operates at steady state with sorbent cycling between steps (a) and (c)), and both the magnesium to calcium ratio and the sodium to magnesium ratio in water that enters the concentration step will be significantly higher than in the feed water.

The concentrate that returns to ion exchange as desorbant therefore also has an elevated magnesium to calcium ratio, and elevated sodium to calcium ratio so that its components can partially displace calcium subgroup components from the loaded sorbent into solution or into separately precipitated solids.

Accordingly, when operated in this manner the difference in the equivalent calcium subgroup components loadings on the sorbent between sorption and desorption, which is the effective transfer of components on a single pass of sorbent, is similar to the effective transfer of these components when ion exchange is operated in such a manner as to also sorb the dominant portion of magnesium (in conventional ion exchange using added chemicals for desorption), with significant chemical additions used for desorption.

It is not necessary to effect complete desorption of the ionic species, particularly calcium subgroup components, in the desorption step (c) to achieve sufficiently low concentrations of the ionic species in the depleted solution exiting step (a) that excessive scaling or fouling is avoided in a corresponding step (b).

In the case of removal of calcium, this feature derives in part from the surprising finding that the selectivity of calcium sorption over sodium sorption onto the sorbent medium (more sorbent cationic capacity taken up with calcium than sodium when each is at the same concentration in equivalents in solution, at equilibrium) is reduced as the concentration effect in step (b) of this embodiment is increased.

Consequently, calcium has a higher tendency to deport to solution when desorbed from a loaded adsorbent by a more concentrated stream containing magnesium and sodium than when sorbed onto a sorbent from a more dilute stream of these components.

Significantly, at higher ionic strengths calcium subgroup components at a particular concentration also have a lower tendency to form solids that could create scale, and to contribute to fouling with other solution components, as reflected in the higher solubility products (expressed in concentration terms) for compounds of calcium subgroup components in high ionic strength solutions.

That is, a higher concentration effect in step b) can reduce the deportment of calcium that enters with feed water to step (a) to the concentration step (b) while increasing the solubility of calcium in the water produced from the concentration step (b).

Further, when desorption is operated in countercurrent mode the deportment of calcium in feed water to step (a) to the concentration step (b) has a minimum at a particular ratio of feed water to sorbent in step (a), with this minimum due to the smaller volume of desorbant that remains available relative to loaded sorbent as the ratio of feed water to sorbent in step (a) further decreases, for a given sorbent circulation rate between steps (a) and (c).

### EXAMPLE 2

In Example 2 of the process of the present invention, the feed water contains sodium salts and at least one salt of calcium subgroup components as well as anions, especially including carbonate and bicarbonate, that can combine with other components when concentrated to produce precipitates, colloids or scale. The magnesium content is low relative to the calcium content (e.g. between zero and one half times the calcium content on an atomic basis).

Cationic ion exchange is applied for almost complete removal of calcium subgroup components from feed water that has first been treated if necessary for removal of iron, such as by oxidation and precipitation. The ionic species depleted solution produced in this cationic exchange may then optionally be acidified for alkalinity adjustment, with acid addition controlled according to pH (targeting pH in the range 5.5 to 6 to avoid carbon dioxide evolution), before it enters the concentration step (b) (which may consist of several stages of membrane or evaporative concentration or combinations conducted in series). The concentrate stream is then optionally further acidified if necessary (depending on concentration process employed) while maintaining a pH that exceeds 5.5, and passed to the desorption step (c). The concentrate stream is used to desorb sufficient calcium subgroup components as to regenerate an effective sorbent for re-use in the sorption stage (a) of the process.

The effectiveness of removal of calcium subgroup components from feed water can be improved by adding dissolved sodium salt to the concentrate stream in order to further increase the ionic strength of the desorbant and improve the effectiveness of desorption. The addition of sodium to the concentrate stream has the effect of reducing the selectivity of uptake onto the sorbent of calcium subgroup components relative to sodium in desorption, while also increasing the sodium concentration in the desorbant, each of which assists completion of desorption.

### EXAMPLE 3

A brackish groundwater having the composition recorded in Table 1 was passed at 12 L/hr and room temperature upwards through a 52 mm diameter column containing 2L (wetted basis) of strong acid cation exchange resin having the initial properties recorded in Table 2 that had first been equilibrated by contact with a large excess of a solution having the composition that is recorded in Table 3, displacing hydronium ions from the resin as a pretreatment.

An identical column was also loaded with the same quantity of this resin, and contacted with 1.0 L/hr of desorbant (a synthetic concentrate) having the composition that is recorded in Table 4, passing upwards, in a desorption stage operated at room temperature.

At intervals of 30 minutes an aliquot of 200 mL of resin was taken from the base of the absorption column, drained, and added to the top of the desorption column. An aliquot of 200 mL of resin was then taken from the base of the desorption column, rinsed (with 1.5 litres of fresh water), drained, and added to the top of the absorption column.

The composition of the solution exiting from the top of the absorption column is recorded as a function of time in this test in Table 4. Table 4 is a run chart for Ca in solution exiting absorption column in Trials I & II in Example 3. The solution calcium concentration reaches a steady state range within about 5 hours.

The steady state concentration ratio (concentration in desorbant as indicated in Table 5 relative to the concentration in the effluent from the absorption column) of calcium achieved in this test is provided in Table 6.

In a similarly conducted test (test II) but with flowrates of resin, feed water and desorbant in absorption and desorption as recorded in Table 7 the corresponding concentration ratio is also recorded in Table 6.

Table 6 shows clearly that at an intermediate resin to water flow ratio between those used in these tests the concentration ratio of calcium will be identical to the solution strength ratio of feed water to desorbant. That is, by modifying the resin circulation rate relative to the feedwater flow it is possible to obtain a target calcium in a concentrated stream at a desired concentration ratio of salts in general.

This example illustrates the ability to substantially remove scaling and fouling promoters such as calcium by cationic ion exchange from water prior to a concentration step while using the concentrate from that concentration step as a desorbant in cationic ion exchange.

Further, the relative magnesium absorption extent (at approximately 30%) was significantly lower than the calcium absorption extent (80 to 90%). Sodium is elevated in the absorption product water relative to the feed water. This exchange illustrates the ability to operate the process of the present invention in such a manner that reagent consumption that would otherwise be required for desorption is significantly reduced (possibly to zero or near zero) due to the concentration effect that is achieved in a concentration stage that produces a desorbant while the concentration effect is itself enabled by selective ion exchange for removal of scaling and fouling promoters.

TABLE 1
Composition of feed water in Example 3

| Component | mg/L |
|---|---|
| Na | 1,650 |
| Mg | 365 |
| Ca | 120 |
| Sr | 2.5 |
| Cl | 3,200 |
| carbonate | 926 (includes bicarbonate) |
| SO4 | 455 |
| Al | 0.30 |
| Ba | 0.04 |
| Fe | 2.9 |
| pH | 8.1 |

TABLE 2
Properties of Initial Cationic Exchange Resin

| Density | kg/L | 1.20-1.30 wet but drained basis |
|---|---|---|
| Ion Exchange Capacity | eq/L | 1.7 |
| Exchangeable H+ | eq/L | 1.7 |

TABLE 3
Resin Equilibration Solution in Example 3

| Component | g/L |
|---|---|
| Na | 20.75 |
| Mg | 26.8 |
| Ca | 0.123 |
| Cl | 110.5 |

Applied at 1.5 litres per litre of resin twice, in each case with stirring for 90 minutes.

TABLE 4
RUN CHART: Adsorption Product Water Calcium Concentration

| | | |
|---|---|---|
| | Feed Water | Product Water |
| Time/Hour | Ca Concentration mg/L | Ca Concentration mg/L |

TRIAL #1

| | | |
|---|---|---|
| 1 | 120 | 20 |
| 2 | 120 | 24 |
| 3 | 120 | 28 |
| 4 | 120 | 28 |
| 5 | 120 | 21 |
| 6 | 120 | 21 |
| 7 | 120 | 20 |
| 8 | 120 | 20 |
| 9 | 120 | 24 |
| 10 | 120 | 24 |
| 11 | 120 | 24 |
| 12 | 120 | 26 |
| 13 | 120 | 24 |
| 14 | 120 | 26 |
| 15 | 120 | 24 |
| 16 | 120 | 21 |

TRIAL #2

| | | |
|---|---|---|
| 1 | 120 | 20 |
| 2 | 120 | 16 |
| 3 | 120 | 14 |
| 4 | 120 | 11 |
| 5 | 120 | 10 |
| 6 | 120 | 14 |
| 7 | 120 | 16 |
| 8 | 120 | 10 |
| 9 | 120 | 16 |
| 10 | 120 | 18 |
| 11 | 120 | 16 |
| 12 | 120 | 16 |
| 13 | 120 | 14 |
| 14 | 120 | 10 |
| 15 | 120 | 14 |
| 16 | 120 | 18 |
| 17 | 120 | 16 |
| 18 | 120 | 11 |
| 19 | 120 | 14 |
| 20 | 120 | 11 |
| 21 | 120 | 10 |
| 22 | 120 | 11 |
| 23 | 120 | 14 |
| 24 | 120 | 10 |
| 25 | 120 | 10 |
| 26 | 120 | 11 |
| 27 | 120 | 11 |
| 28 | 120 | 11 |

TABLE 5
Composition of desorbant in Example 3

| Component | mg/L |
|---|---|
| Na | 20752 |
| Mg | 5359 |
| Ca | 238 |
| Cl | 37317 |
| Carbonate (as HCO3⁻) | 11422 (includes bicarbonate) |
| SO4 | 5322 |
| pH | 7.16 |

TABLE 6
Ca Concentration Ratio (Desorbant to Absorption
Product Water) In Example 3

| | Ratio (I) | (II) |
|---|---|---|
| Ca concentration ratio | 9.9 | 19.8 |
| Desorbant/Feed water | 12.6 | 12.6 |
| ionic strength ratio (eq/eq) | | |

TABLE 7
Desorbant, Feed water and Resin Flowrates in Example 3
Trial I

| Feed Water | 18.6 L/h |
|---|---|
| Desorbant | 1.4 L/h |
| Resin | 0.4 L/h |
| Ratio (feed water/resin) | 45.3 |

Trial II

| | |
|---|---|
| Feed Water | 12.4 L/h |
| Desorbant | 1.0 L/h |
| Resin | 0.4 L/h |
| Ratio (feed water/resin) | 30.5 |

The final concentration of scaling and fouling promoters in water exiting step (a) in the process of the present invention will be determined in the case that the sorbent is cycled between steps (a) and (c) by:
the particular sorbent chosen for use, especially its ion exchange capacity and relative selectivity for sorption of particular solution components;
the feed water composition (including composition effects from additions made) and temperature;
the concentration ratio applied in the chosen configuration of concentration steps;
the addition of chemicals to the water that enters step (b);
the addition of chemicals and supplementary desorbants to the concentrate that is used for desorption from the concentration step (b);
the water to sorbent ratio in input streams to step (a);
the proportion of the concentrate from step (b) that is used in desorption in step (c);
the average residence times of the resin, water and desorbant in each of steps (a) and (c); and
the physical configuration and number of stages of the contacting steps (a) and (c).

By virtue of the present invention, the current limitation on concentration ratio that is acceptable in the concentration step will no longer be established by the most limiting scaling and fouling promoters in the feed water. The maximum concentration ratio now may be established by less limiting concentrations and forms of components in water entering the concentration step or steps, including silica, but in a process that has significantly reduced costs compared with other techniques. In this manner the area required for disposal of concentrated streams is reduced, natural evaporation becomes a more practical means of final water removal from the salts, and the possibility of subsequent recovery of valuable evaporite components, such as soda ash, is not lost by bulk acidification or made more difficult by unnecessary dilution with added chemicals such as salt.

That is, the process enables sufficient flexibility in design and operating features that it will normally be possible to operate the integrated process with a wide variety of feed waters and concentration ratios, while providing for streams that enter the concentration and desorption steps (b) and (c) that have significantly reduced scaling and fouling potential for the concentration effect achieved, but at much lower consumption of added reagents than would otherwise be required.

Specific advantages of the present invention therefore include:
sufficient selectivity that reagent consumption, if any, is specific to the ionic species that contribute most to scale formation in the concentration step;
relatively low energy consumption so that the energy costs of the process are not significantly increased as compared with the sum of the costs of the individual process steps;
low susceptibility of the process to the impacts of scaling and fouling;
the ability to provide an industrially realistic means of achieving high concentration effects in a concentration stage of water treatment, whether membrane based or evaporative, without a commensurate increase in costs from reagents used to remove and or control promoters of scaling and fouling
ion exchange operated according to the present invention may have little or no disadvantage encountered arising from elevated sorbent circulation rate, while a significant advantage in avoidance of purchased reagent consumption is conferred.

Finally, it is to be understood that many modifications and/or alterations may be made without departing from the spirit and scope of the present invention as outlined herein.

1. A water treatment process for substantially removing one or more ionic species from a feed water comprising an ion containing aqueous solution to produce a treated water product, the process including:
(a) a sorption step, comprising contacting a solid sorbent with said feed water to produce a solution depleted in said one or more ionic species and a loaded sorbent;
(b) a concentrating step, comprising concentrating an inlet stream including the ionic species depleted solution to produce a concentrate rich in said one or more ionic species and said treated water product; and
(c) a desorbing step, comprising contacting said loaded sorbent with an aqueous desorbant including said concentrate to thereby desorb at least some of said one or more ionic species from said loaded sorbent.

2. The water treatment process of claim 1, wherein said sorption step comprises an ion exchange step and said solid sorbent comprises an ion exchange material.

3. The water treatment process of claim 2, wherein the ion exchange material comprises an ion exchange resin, preferably in granular form.

4. The water treatment process of claim 2, wherein the ion exchange material is a cation exchanger.

5. The water treatment process of claim 1, wherein said ionic species promote fouling and/or scaling.

6. The water treatment process of claim 1, wherein said ionic species include divalent and/or trivalent cation containing ionic species.

7. The water treatment process of claim 1, wherein said ionic species include one or more of calcium, barium, strontium, and iron-containing species.

8. The process of claim 1, wherein said ionic species include calcium containing species.

9. The water treatment process of claim 1, wherein the sorption step (a) is conducted via countercurrent contacting of said solid sorbent and said aqueous solution.

10. The water treatment process of claim 1, wherein the sorption step (a) is continuous.

11. The water treatment process of claim 1, wherein the desorbing step (c) is conducted via countercurrent contacting of said loaded sorbent and said concentrate.

12. The water treatment process of claim 1, wherein the desorption step (c) is continuous.

13. (canceled)

14. The water treatment process of claim 1, wherein said concentrating step includes a membrane process which utilises a membrane for producing said concentrate and said treated water product.

15. The water treatment process of claim 1, wherein said concentrating step comprises reverse osmosis.

16. The water treatment process of claim 1, wherein said concentrating step includes an evaporative process.

17. The water treatment process of claim 1, further including the step of:
(d) recycling the solid sorbent after desorption to said sorption step (a).

18. The water treatment process of claim 1, further including adding one or more process enhancing additives to one or more steps of the process, wherein said one or more process enhancing additives includes acidifying additives and/or antiscalants.

19. (canceled)

20. The water treatment process of claim 18, wherein said one or more process enhancing additives are added to the feed stream in step (b) and/or said concentrate prior to step (c).
